(19) United States
(12) Patent Application Publication
(10) Pub. No.: US 2025/0155615 A1
(43) Pub. Date: May 15, 2025

(54) MIRROR ASSEMBLY WITH FORMED REFLECTIVE ELEMENT SUBSTRATE

(71) Applicant: Magna Mirrors of America, Inc., Holland, MI (US)

(72) Inventor: Justin E. Sobecki, Rockford, MI (US)

(21) Appl. No.: 18/726,148

(22) PCT Filed: Jan. 4, 2023
(86) PCT No.: PCT/US2023/060057

§ 371 Date: Jul. 2, 2024

Related U.S. Application Data
(60) Provisional application No. 63/266,369, filed on Jan. 4, 2022.

(51) Int. Cl. G02B 5/10; B60R 1/06; B60R 1/08

(52) U.S. Cl. CPC G02B 5/10; B60R 1/06; B60R 1/088

(57) ABSTRACT

A vehicular exterior rearview mirror assembly includes a mirror head and a reflective element accommodated by the mirror head. The reflective element includes a bi-directional aspheric curved glass substrate and a mirror reflector coated at a surface of the bi-directional aspheric curved glass substrate. The size of the reflective element has a width dimension of less than 15 cm and a height dimension of less than 9 cm. The reflective element, as viewed when the equipped vehicle is normally operated, provides a rearward view of at least 15 degrees horizontally relative to the side of the equipped vehicle. Curvature of the reflective element is established, at least in part, by coordinates of a driver's eye viewpoint location and coordinates of an image plane that will provide a desired view from the driver's eye viewpoint location based at least in part on the size of the reflective element.

### CROSS REFERENCE TO RELATED APPLICATIONS

The present application is a national stage patent application of PCT/US2023/060057, filed Jan. 4, 2023, which claims the filing benefits of U.S. provisional application Ser. No. 63/266,369, filed Jan. 4, 2022, which is hereby incorporated herein by reference in its entirety.

### FIELD OF THE INVENTION

The present invention relates generally to exterior rearview mirror assemblies and, more particularly, to an exterior rearview mirror assembly that has a mirror reflective element that provides a wide angle field of view to the driver of the vehicle.

### BACKGROUND OF THE INVENTION

It is known to provide a vehicular exterior rearview mirror assembly that has a curved or bent reflective element to provide a wide angle rearward field of view to the driver of the vehicle. Typical automotive mirror reflective elements incorporate convex and aspheric bends to produce the desired larger or wider field of view as compared to flat mirror reflective elements. Such curved or bent reflective elements are typically disposed at passenger side exterior rearview mirror assemblies in the U.S., given that Federal Motor Vehicle Safety Standard FMVSS 111 (which is hereby incorporated by reference herein in its entirety) prescribes that the driver side mirror element be a plane or flat mirror with unit magnification. ECE 46R (see FIG. 2) provides requirements for exterior mirrors on vehicles and sets minimum radius of curvature requirements and tolerances.

The application of convex and aspheric mirrors typically causes distortion of images and make it difficult for a driver to gauge distance to the rear (hence the FMVSS 111 requirement for the indication that “objects in mirror are closer than they appear”). In order to limit or reduce this distortion, the radius of curvature of the reflective element is typically in the range of about 1000 mm to about 2000 mm for passenger side convex mirrors used in the U.S. If the mirror reflective element includes an aspheric wide angle optic or element at an outboard portion thereof, such aspheric regions are typically delineated or demarcated to indicate to the driver as to the extra distorted region of the mirror reflective element. The design of such bent or curved reflective elements result in design parameters for the physical size of the outside or exterior reflective element on the particular vehicle application.

A “Freeform Mirror” allows us to meet FOV requirements with a smaller mirror. This provides a mirror with reduced mass and reduced drag. However, such freeform mirrors require expensive software to establish the freeform surface.

### SUMMARY OF THE INVENTION

An exterior rearview mirror assembly has a shape or profile or curvature that provides a substantially non-distorted wide angle field of view and that allows for a reduced size reflective element. The reflected image as seen and judged by a driver seated in and normally operating the vehicle and with such a mirror reflective element mounted at a driver side mirror assembly and/or a passenger side mirror assembly appears undistorted or substantially undistorted as such a driver is used to seeing in a flat or plane driver side mirror. The mirror reflective element is formed as a bi-directional aspheric mirror.

These and other objects, advantages, purposes and features of the present invention will become apparent upon review of the following specification in conjunction with the drawings.

### BRIEF DESCRIPTION OF THE DRAWINGS

FIG. 1 is a rear view of an exterior rearview mirror assembly;

FIG. 2 is a plan view showing ECE 46R required fields of view provided by exterior rearview mirrors of a vehicle;

FIGS. 3A and 3B are schematics of a curved mirror reflective element that provides a desired field of view based on a radius of curvature requirement;

FIG. 4 is a schematic of a curved mirror reflective element that provides a desired field of view using a bi-directional aspheric curvature;

FIGS. 5A and 5B show curvature analysis of the bi-directional aspheric curvature;

FIG. 6 is a simulation setup for determining the bi-directional aspheric curvature;

FIG. 7 is a comparison of mirror reflective elements formed with a torus and aspheric curvature, a spherical and aspheric curvature, and a bi-directional aspheric curvature; and

FIG. 8 is a comparison of mirror reflective elements formed with a bi-directional aspheric curvature and a freeform curvature.

### DESCRIPTION OF THE PREFERRED EMBODIMENTS

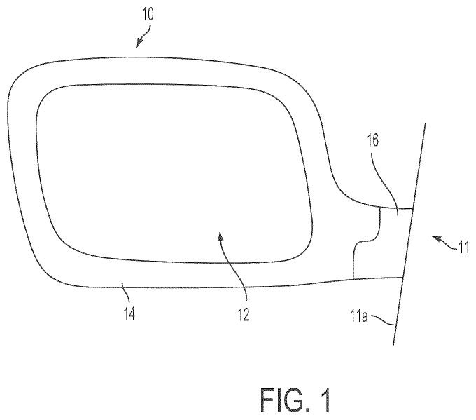

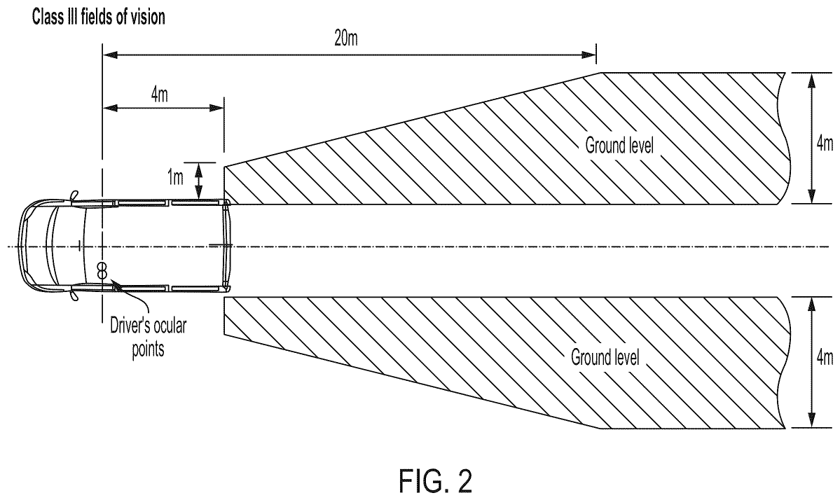

Referring now to the drawings and the illustrative embodiments depicted therein, an exterior rearview mirror assembly 10 for a vehicle 11 includes a mirror reflective element 12 received in and/or supported at or by a mirror shell or casing or head portion 14 (FIG. 1). The mirror casing or head portion 14 may be fixedly attached at a mounting arm or base 16 at the side 11a of the vehicle 11 or may be movably mounted to a mounting arm or base or portion 16, and may comprise a breakaway mirror (where the mirror head portion may be manually pivoted about the mounting arm or base) or may comprise a powerfold mirror (where the mirror head portion may be pivoted via an actuator assembly or adjustment device). The mounting arm or base 16 of the mirror assembly 10 is mounted at the side 11a of the host or subject vehicle 11, with the reflective element 12 providing a rearward field of view along the respective side of the vehicle to the driver of the vehicle, as discussed below. The mirror reflective element is formed with a bi-directional aspheric curvature and meets all ECE 46R requirements (radius of curvature and field of view requirements), and uses a smooth relatively consistent surface that reduces distortion in the reflected images.

The reflective element is formed to provide an undistorted or minimally distorted or substantially undistorted mirror image while achieving or delivering a wide angle or enhanced rearward and sideward field of view to the driver of the vehicle, such as a field of view that is at least about 15 degrees and preferably is at least about 20 degrees and more preferably is at least about 30 degrees and more preferably is at least about 35 degrees. The reflective element provides such a field of view while providing a substantially non-distorted image while comprising a reduced dimensional size reflective element, such as a reflective element having a width dimension (the lateral or horizontal dimension of the reflective element when normally mounted at the side of a vehicle) of less than about 11 cm, more preferably is no greater than about 9 cm, and more preferably is no greater than about 7 cm and a height dimension (the vertical dimension of the reflective element when normally mounted at the side of a vehicle) of less than about 10 cm, more preferably is no greater than 7.5 cm, and more preferably is no greater than about 6 cm.

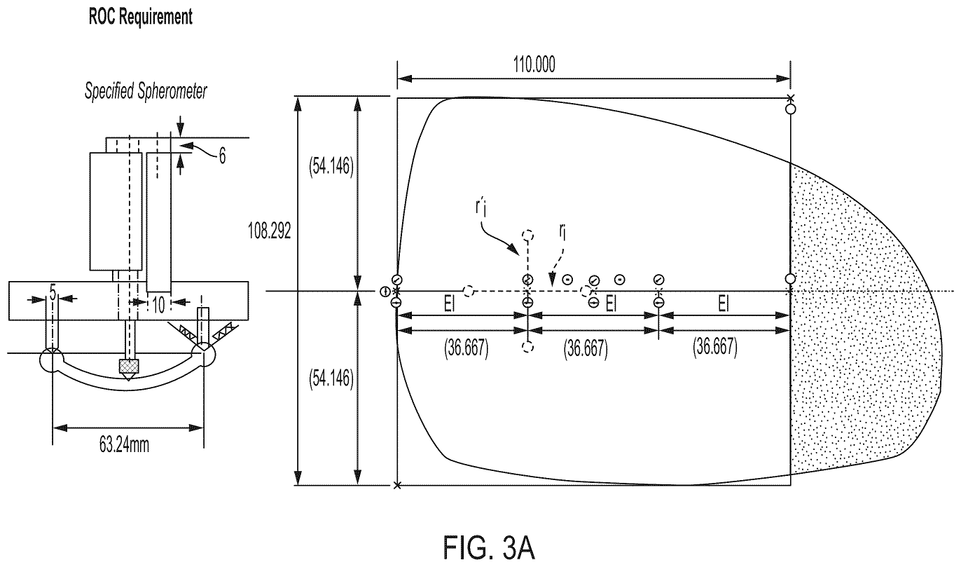

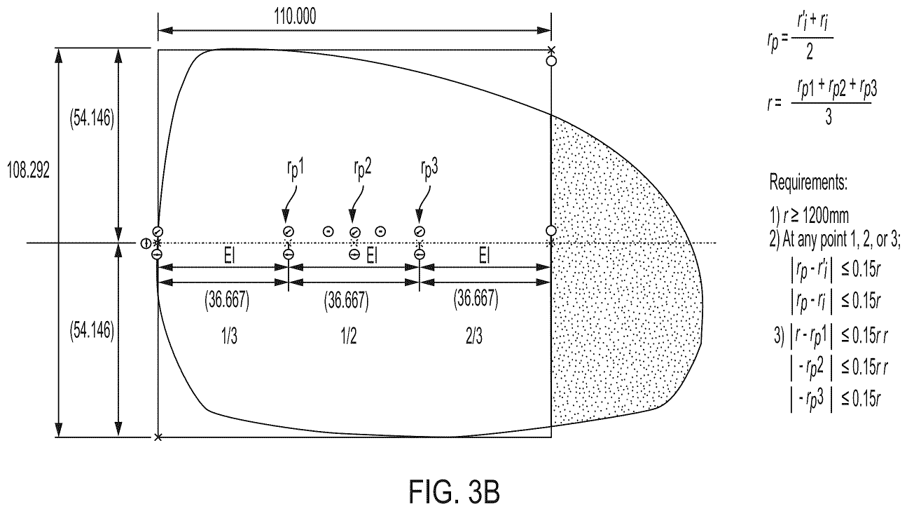

As shown in FIGS. 3A and 3B, the mirror reflective element must have an average radius of curvature (the average of the radius of curvature at each of three specified points at the reflective element) of greater than 1200 mm, with the requirements at each of the three points shown in FIG. 3B. Optionally, such a form may be provided by a torus shape, which may be relatively easy to design and manufacture. Such a torus shape may provide constant or uniform image magnification throughout the reflected image, but may only reduce the mirror size by around 5 percent. Optionally, such a form may be provided via a freeform surface, which requires special software that ray traces from an eye point to a FOV target plane and determines the optimal surface normal at every point on the mirror surface to meet the FOV target and ROC requirements. Such a freeform surface may reduce the mirror size by up to around 19 percent, but may not control the distortion.

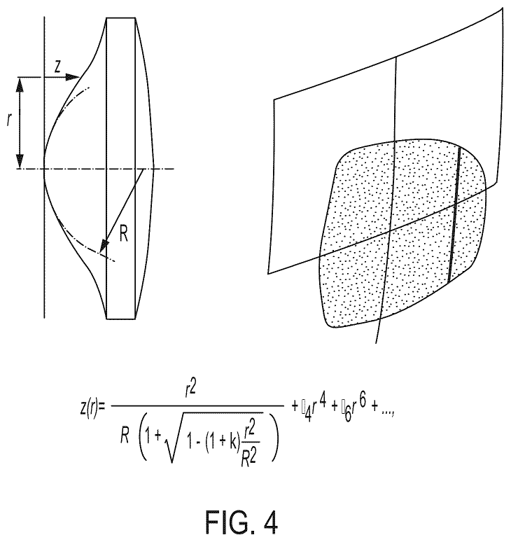

As shown in FIG. 4, the mirror reflective element may be designed and formed as a bi-directional aspheric form, where a horizontal aspheric curve is swept on a vertical aspheric curve. Both curves may have a unique k, R (ROC), and αₙ values in the equation for z (r) (see FIG. 4). Various parameters may be used (e.g., α₄C) to reduce waviness in the mirror surface. Such a bi-directional aspheric curvature may allow for reduction in mirror size of around 19 percent or more. The mirror curvature is made up of two aspheric curvatures, with one curvature curving along a vertical path of the glass substrate (along or across the height dimension of the glass substrate) and the other curvature curving along a horizontal path of the glass substrate (along or across the width dimension of the glass substrate).

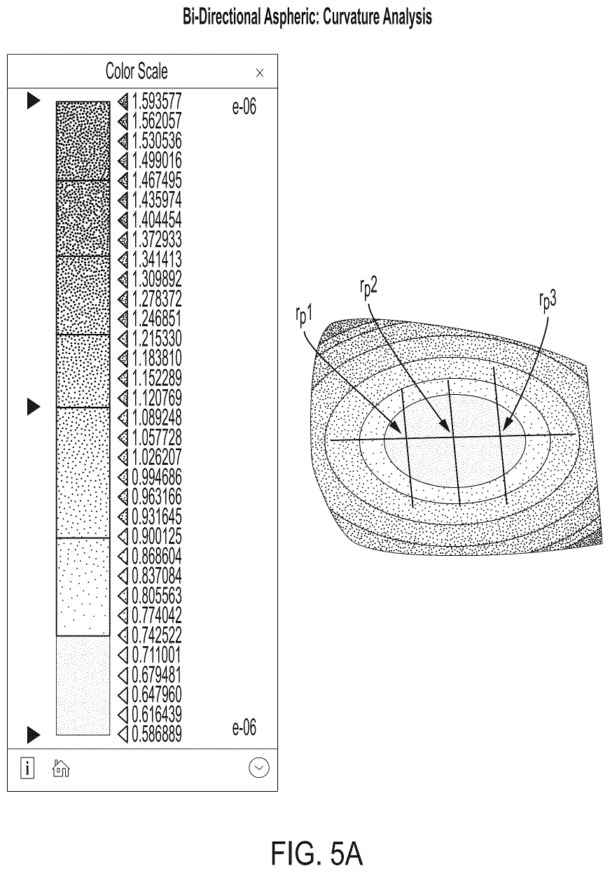

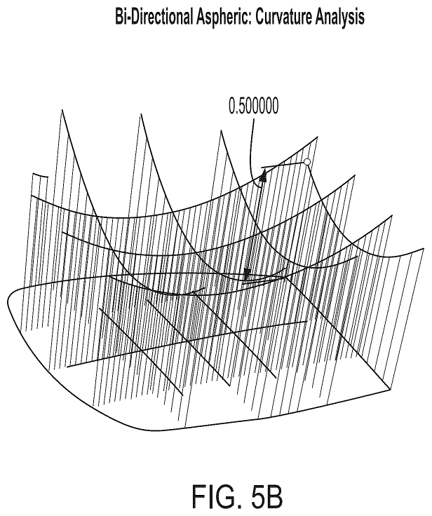

In setting up the curvature equations, the goal is to minimize FOV match to a spherical mirror. The system may ray trace rays on bi-directional aspheric curvature surface and on a spherical surface to a target plane. The system may sum up the difference between each ray's end point. The parameters are then determined based on the ECE R46 requirements (r≥1230 for tolerance) and the desired surface area (e.g., less than about 80 percent of the spherical mirror area). The variables are determined by warping parameters to shrink the mirror in in each direction, with the aspheric equation inputs for each direction (k, R (ROC), and αₙ values). The curvature analysis of the bi-directional aspheric curvature is shown in FIGS. 5A and 5B.

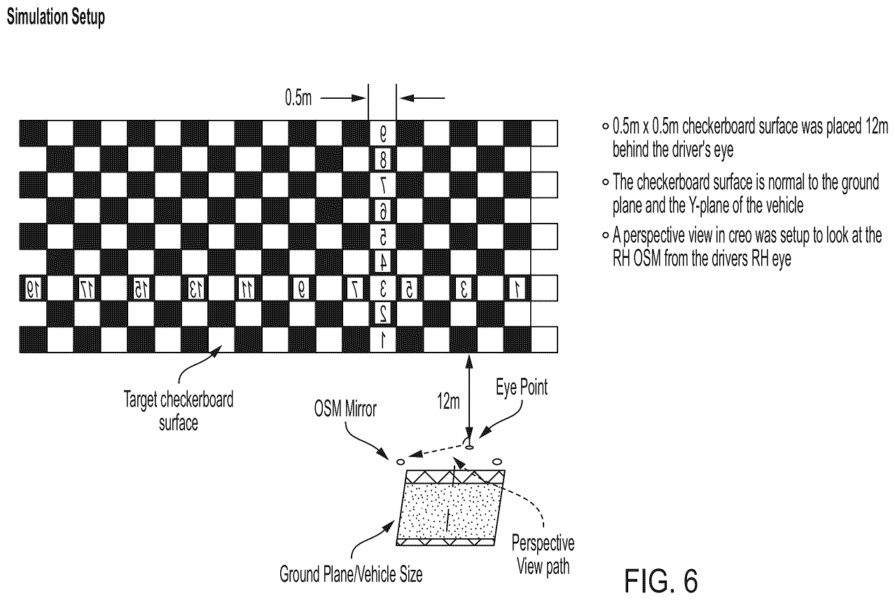

To simulate and develop the bi-directional aspheric curvature, a 0.5 m×0.5 m checkerboard surface is placed at least about 10 meters, such as, for example, about 12 meters or at least about 12 meters, behind the driver's eye location (see FIG. 6). The checkerboard surface is normal or perpendicular to the ground plane (i.e., the checkerboard surface is vertically oriented) and the Y-plane of the vehicle. A perspective view is setup (such as, e.g., in Creo CAD software) to look at the RH OSM from the driver's RH eye location. The checkerboard surface provides an object plane that the mirror reflects toward the driver's eye location. The bi-directional aspheric curvature of the mirror reflective element is determined to so as to provide a reduced reflective area of the reflective element (the image plane) while providing at least a minimal rearward view (of the object plane) to the driver's eye location.

The image plane is representative of the mirror reflective element at the side of the vehicle, and the object plane defines the size and shape and border of the rearward field of view at a distance behind the image plane or mirror reflective element that is determined by where the rearward field of view of the mirror reflective element intersects the ground plane at which the vehicle is located. In other words, the object plane represents the field of view at a location rearward of the vehicle that will fill or be encompassed by the rearward field of view of that mirror reflective element. Curvature of the mirror reflective element is established by determining curve parameters that establish the two curvatures, with a horizontal aspheric curve (that curves along a horizontal section of the reflective element) being swept vertically across the mirror reflective element on a vertical aspheric curvature (that curves along a vertical section of the reflective element), or with the vertical aspheric curve being swept horizontally or laterally across the mirror reflective element on the horizontal aspheric curvature. The horizontal aspheric curve may have a common horizontal curvature at each horizontal section across the reflective element and the vertical aspheric curve may have a common vertical aspheric curvature at each vertical section across the reflective element. In other words, the vertical aspheric curve has the same aspheric curvature at various vertical sections across the reflective element, while the horizontal aspheric curve has the same aspheric curvature at various horizontal sections across the reflective element.

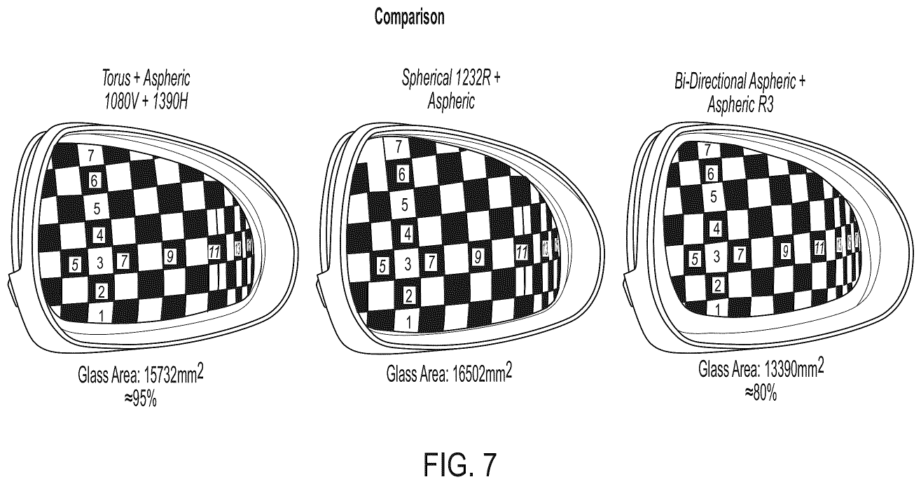

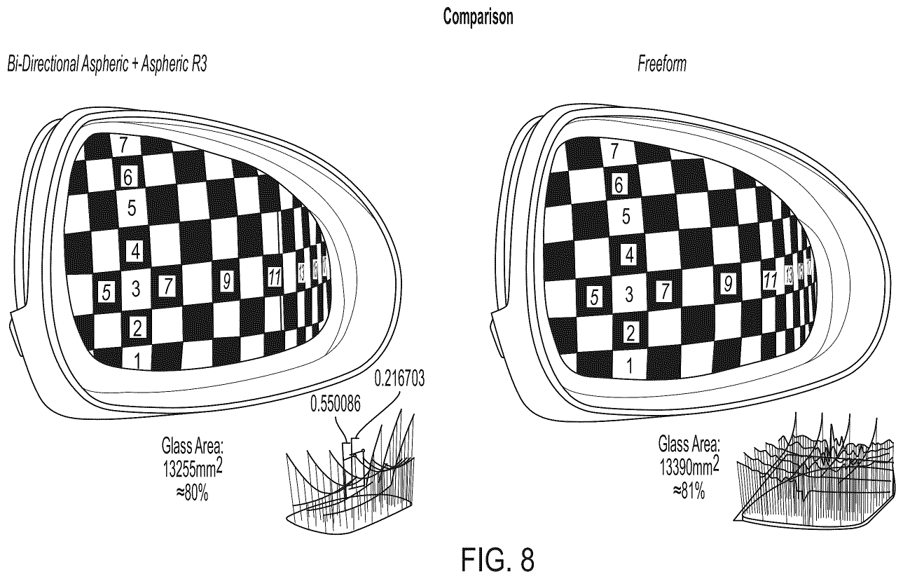

Thus, the reflective element may be formed with a bi-directional aspheric curvature. As shown in FIG. 7, such a bi-directional aspheric curvature mirror provides a reduction in glass area (as compared to a torus curvature or a spherical and aspherical curvature) while providing the required view. As shown in FIG. 8, the bi-directional aspheric curvature mirror also provides a reduction in glass area (as compared to a freeform curvature).

The reflective element may comprise a single glass substrate that is bent or curved or formed to have the desired curvature or profile. The glass substrate may be coated with a mirror reflector at its rear surface before or after forming of the substrate with the desired or selected curvature or profile. Optionally, the reflective element may comprise an electro-optic reflective element, such as an electrochromic reflective element, whereby two glass sheets are formed or curved or bent to have matching desired curvatures or profiles and then mated or laminated together with an electro-optic medium sandwiched therebetween. In such an electro-optic application, the rear substrate and the reflector coated surface of the rear substrate may be formed to have the desired or appropriate or selected profile, while the front substrate is formed to generally correspond to the curvature or form of the rear substrate. The rear glass substrate may be coated with a mirror reflector at a surface thereof (such as a front or rear surface of the rear glass substrate) before or after forming of the rear glass substrate with the desired or selected curvature or profile.

The size or width and height dimensions of the outside mirror reflective element may be reduced by utilizing the mirror substrate that provides a desired field of view with reduced optical distortion. Nominally, the mirror reflective element may be reduced by about 15 percent to about 25 percent in size without a discernable impact to the driver's perception or field of view. The profile of the mirror reflective element may be designed or formed so that the mirror provides reduced rectilinear distortion.

Thus, an enhanced process is provided for manufacturing mirror substrates for exterior mirror reflective elements for exterior or outside mirror assemblies for vehicles. The mirror substrates and reflective elements provide a desired or enhanced field of view with reduced or minimal distortion, and are manufactured in a manner that allows for mass production of the substrates and reflective elements.

The mirror reflective element is designed or configured to provide a desired rearward field of view to the driver of the vehicle when the mirror reflective element and exterior rearview mirror assembly are normally mounted at the vehicle and when the driver of the vehicle is normally operating the vehicle. A desired curvature or profile of a reflective element that provides reduced distortion may be determined by entering coordinates of a viewpoint and coordinates of an image plane that will provide a desired angled field of view to a person viewing from the viewpoint.

The reflective element and/or the process of establishing the reflective element profile may utilize aspects of the elements and processes described in U.S. Pat. Nos. 6,412,961; 6,321,570; 5,980,050; 5,938,810; 5,857,358; 4,449,786 and/or 4,264,144, and/or International Publication Nos. WO 2011/133400 and/or WO 2010/144816, which are all hereby incorporated herein by reference in their entireties. Optionally, the profile or curvature of the reflective element may be established utilizing aspects of the transformation processes and equations described in U.S. Pat. Nos. 8,917,437 and/or 8,180,606, and/or U.S. Publication No. US-2012-0092784, which are hereby incorporated herein by reference in their entireties, such that the reflective element provides the desired wide angle field of view with reduced or substantially absent image distortion in the reflected image viewed by the driver when utilized on the vehicle.

Optionally, the reflective element may attach to a mounting surface of or at the mirror head portion or the reflective element may be received in or partially received in a receiving structure or bezel structure at the mirror head portion (and may be attached at a mounting plate or backing plate that may be adjustably mounted or disposed in the mirror casing and that may be adjustable via a powered mirror reflective element adjustment actuator to allow for adjustment of the mirror reflective element relative to the mirror casing to establish a desired rearward field of view to the driver of the vehicle). The mirror reflective element may comprise a single pane reflective element or an electro-optic reflective element (such as an electrochromic reflective element) with front and rear substrates and an electro-optic medium sandwiched therebetween, such as discussed below. Optionally, the reflective element may have a fillet or rounded edge or radius established around its perimeter edge, such as to meet safety regulations is exposed, and may not include a bezel portion that encompasses the perimeter edge of the reflective element when the reflective element is attached to the mirror head portion 14 (such as described in U.S. Pat. No. 8,915,601, which is hereby incorporated herein by reference in its entirety). The reflective element is adjustably mounted or supported at or in or partially in the mirror head portion, such as via a reflective element actuator or the like.

The exterior rearview mirror assembly may utilize aspects of the mirror assemblies described in U.S. Publication Nos. US-2021-0331625; US-2021-0316664; US-2021-0213880; US-2020-0353867 and/or US-2020-0223364, and/or U.S. Pat. Nos. 11,325,535; 10,099,618; 9,827,913; 9,487,142; 9,346,403 and/or 8,915,601, which are all hereby incorporated herein by reference in their entireties. The exterior rearview mirror assembly includes a mounting arm and a mirror head having a mirror reflective element and an actuator. The mounting arm is received through an aperture in the mirror head and the actuator is attached at the mounting arm inside the mirror head. The actuator is electrically operable to adjust the mirror head relative to the mounting arm. The actuator attaches at the mounting arm and to the mirror head. The mirror actuator is electrically operable to adjust the mirror reflective element and the mirror head (which may include a mirror casing) together and in tandem relative to the mounting arm to vertically and horizontally adjust a field of view of a driver of the vehicle who is viewing the mirror reflective element. The aperture allows for movement of the mirror head relative to the mounting arm during operation of the mirror actuator. The actuator may include an actuator housing that houses first and second motors that drive respective first and second gears. When the first motor is electrically operated, the first gear causes pivoting of the mirror head about a vertical pivot axis, and when the second motor is electrically operated, the second gear causes pivoting of the mirror head about a horizontal pivot axis

Optionally, the mirror head portion or mirror casing or a back plate may include a perimeter framing portion or bezel portion that extends around the perimeter edges of the reflective element to support the reflective element and frame the reflective element at the mirror assembly (such as by utilizing aspects of the mirror assemblies described in U.S. Pat. No. 7,581,859, which is hereby incorporated herein by reference in its entirety). The perimeter bezel portion may be narrow or small depending on the particular application of the reflective element and mirror reflector sub-assembly. Optionally, the mirror reflective element may comprise a bezelless or frameless reflective element (such as the types described in U.S. Pat. Nos. 7,626,749; 7,184, 190 and/or 7,255,451, and/or U.S. Publication No. US-2006-0061008, which are hereby incorporated herein by reference in their entireties), whereby the back plate may not include a perimeter framing portion or bezel portion around the perimeter of the reflective element. The reflective element assembly may utilize aspects of the mirror assemblies shown and/or described in International Publication Nos. WO 2013/126,719; WO 2013/071070; WO 2012/051500; WO 2010/124064 and/or WO 2011/044312, and/or U.S. Pat. Nos. 7,253,723 and/or 8,154,418, which are all hereby incorporated herein by reference in their entireties.

Optionally, the mirror assembly and/or reflective element may include a wide angle reflector or blind spot viewing aid or the like to provide a wide angle field of view of the blind spot area at the side of the vehicle to the driver of the vehicle. The mirror reflective element may include a first or principal mirror reflective element portion and a second or auxiliary wide angle reflective element portion or reflective optic. The auxiliary wide angle portion or optic may be integrally formed with the mirror reflective element 12, such as by utilizing aspects of the mirror assemblies described in U.S. Pat. Nos. 8,021,005; 7,934,844; 7,887,204; 7,824,045 and 7,748,856, which are hereby incorporated herein by reference in their entireties, or the auxiliary wide angle portion or optic may comprise a separate element or optic, such as by utilizing aspects of the mirror assemblies described in U.S. Pat. Nos. 7,255,451; 7,195,381; 6,717,712; 7,126,456; 6,315,419; 7,097,312; 6,522,451; 6,315,419; 5,080,492; 5,050,977 and/or 5,033,835, which are hereby incorporated herein by reference in their entireties.

Optionally, the exterior mirror assembly may include a heater element or pad at the rear of the reflective element and operable to heat the reflective element. The heater pad may comprise a mirror defrost/demisting heater such as a heater pad or a heater film or a heater element, and may provide an anti-fogging of de-fogging feature to the exterior mirror assembly, and may utilize aspects of the heater elements or pads described in U.S. Pat. Nos. 8,058,977; 7,400,435; 5,808,777; 5,610,756 and/or 5,446,576, and/or U.S. Publication Nos. US-2008-0011733 and/or US-2011-0286096, which are hereby incorporated herein by reference in their entireties. The heater element may include electrical contacts that extend rearward therefrom and through an aperture or apertures of the attaching portion of the back plate for electrical connection to a wire harness or connector of the mirror assembly, or the back plate and/or heater pad may include suitable electrical connectors and connections incorporated therein (such as by utilizing aspects of the mirror assembly described in U.S. Pat. No. 7,400,435, which is hereby incorporated herein by reference in its entirety) for electrically connecting the heater pad (or other suitable electrical connectors may be utilized, such as electrical leads or wire harnesses or pigtails or other separate connectors or cables or the like).

Optionally, the rearview mirror reflective element assembly comprises an electro-optic or electrochromic reflective element assembly or cell, such as an electrochromic mirror reflective element assembly with coated substrates that are coated utilizing principles disclosed in commonly assigned U.S. Pat. Nos. 7,310,178; 7,274,501; 7,255,451; 7,195,381; 7,184,190; 6,690,268; 5,140,455; 5,151,816; 6,420,036; 6,245,262; 6,178,034; 6,154,306; 6,002,544; 5,567,360; 5,525,264; 5,610,756; 5,406,414; 5,253,109; 5,076,673; 5,073,012; 5,117,346; 5,724,187; 5,668,663; 5,910,854; 5,142,407 and/or 4,712,879, which are hereby incorporated herein by reference in their entireties.

Therefore, the vehicular exterior rearview mirror assembly includes a mirror head and a reflective element accommodated by the mirror head. The reflective element comprises a bi-directional aspheric curved glass substrate and a mirror reflector coated at a surface of the bi-directional aspheric curved glass substrate. The size of the reflective element has a width dimension of less than 15 cm and a height dimension of less than 9 cm. The reflective element, when accommodated by the mirror head and with the vehicular exterior rearview mirror assembly disposed at a side of a vehicle equipped with the vehicular exterior rearview mirror assembly, and as viewed when the equipped vehicle is normally operated, provides a rearward view of at least 15 degrees horizontally relative to the side of the equipped vehicle. Curvature of the reflective element is established, at least in part, by coordinates of a driver's eye viewpoint location and coordinates of an image plane that will provide a desired view from the driver's eye viewpoint location based at least in part on the size of the reflective element.

The bi-directional aspheric curved glass substrate may have the mirror reflector coated at a rear surface thereof. The reflective element may have a reduced size that is at least 25 percent smaller than that of a planar reflective element of equivalent field of view. The image plane represents a desired field of view to a person viewing from the driver's eye viewpoint location, and an object plane represents a field of view of the person at a location rearward of the equipped vehicle. The mirror head is mountable at a passenger-side of the equipped vehicle, and the reflective element comprises a passenger-side reflective element.

The reflective element may comprise a non-electro-optic reflective element. The reflective element may comprise an electrochromic reflective element having a front substrate and a rear substrate and an electrochromic medium disposed between the front substrate and the rear substrate, and the rear substrate may comprise the bi-directional aspheric curved glass substrate.

The reflective element may be configured to provide a rearward field of view of at least 20 degrees relative to the side of the equipped vehicle. The reflective element may be configured to provide a rearward field of view of at least 30 degrees relative to the side of the equipped vehicle. The reflective element may be configured to provide a rearward field of view of at least 35 degrees relative to the side of the equipped vehicle.

The curvature of the reflective element may be determined by establishing curve parameters that provide a horizontal aspheric curvature that curves along a horizontal section of the reflective element, and a vertical aspheric curvature that curves along a vertical section of the reflective element. The horizontal aspheric curvature may be swept vertically across the reflective element on the vertical aspheric curvature. The vertical aspheric curvature may be swept horizontally across the reflective element on the horizontal aspheric curvature.

Optionally, the vehicular exterior rearview mirror assembly may comprise a mirror head and a reflective element accommodated by the mirror head, the reflective element comprising a bi-directional aspheric curved glass substrate and a mirror reflector coated at a surface of the bi-directional aspheric curved glass substrate. The size of the reflective element has a width dimension of less than 15 cm and a height dimension of less than 9 cm. The reflective element, when accommodated by the mirror head and with the vehicular exterior rearview mirror assembly disposed at a passenger side of a vehicle equipped with the vehicular exterior rearview mirror assembly, and as viewed when the equipped vehicle is normally operated, provides a rearward view of at least 30 degrees horizontally relative to the passenger side of the equipped vehicle. Curvature of the reflective element is established, at least in part, by coordinates of a driver's eye viewpoint location and coordinates of an image plane that will provide a desired view from the driver's eye viewpoint location based at least in part on the size of the reflective element. The curvature of the reflective element is determined by establishing curve parameters that provide a horizontal aspheric curvature that curves along a horizontal section of the reflective element, and a vertical aspheric curvature that curves along a vertical section of the reflective element. The horizontal aspheric curvature may be swept vertically across the reflective element on the vertical aspheric curvature, or the vertical aspheric curvature may be swept horizontally across the reflective element on the horizontal aspheric curvature.

The bi-directional aspheric curved glass substrate may have the mirror reflector coated at a rear surface thereof. The reflective element may have a reduced size that is at least 25 percent smaller than that of a planar reflective element of equivalent field of view. The image plane represents a desired field of view to a person viewing from the driver's eye viewpoint location, and an object plane represents a field of view of the person at a location rearward of the equipped vehicle.

The reflective element may comprise a non-electro-optic reflective element. The reflective element may comprise an electrochromic reflective element having a front substrate and a rear substrate and an electrochromic medium disposed between the front substrate and the rear substrate, with the rear substrate comprising the bi-directional aspheric curved glass substrate. The reflective element may be configured to provide a rearward field of view of at least 35 degrees relative to the passenger side of the equipped vehicle.

Optionally, the vehicular exterior rearview mirror assembly may comprise a mirror head and a reflective element accommodated by the mirror head, the reflective element comprising a bi-directional aspheric curved glass substrate and a mirror reflector coated at a surface of the bi-directional aspheric curved glass substrate. The size of the reflective element has a width dimension of less than 15 cm and a height dimension of less than 9 cm. The reflective element, when accommodated by the mirror head and with the vehicular exterior rearview mirror assembly disposed at a passenger side of a vehicle equipped with the vehicular exterior rearview mirror assembly, and as viewed when the equipped vehicle is normally operated, provides a rearward view of at least 30 degrees horizontally relative to the passenger side of the equipped vehicle. Curvature of the reflective element is established, at least in part, by (i) a driver's eye viewpoint location, (ii) coordinates of an image plane that will provide a desired rearward view from the driver's eye viewpoint location, and (iii) coordinates of an object plane that represents a rearward field of view of a person viewing from the driver's eye viewpoint location, the object plane being at a location at least ten meters rearward of the driver's eye viewpoint location. The reflective element has a reduced size that is at least 25 percent smaller than that of a planar reflective element of equivalent field of view.

The bi-directional aspheric curved glass substrate may have the mirror reflector coated at a rear surface thereof. The reflective element may comprise a non-electro-optic reflective element. The reflective element may comprise an electrochromic reflective element having a front substrate and a rear substrate and an electrochromic medium disposed between the front substrate and the rear substrate, with the rear substrate comprising the bi-directional aspheric curved glass substrate. The reflective element may be configured to provide a rearward field of view of at least 35 degrees relative to the passenger side of the equipped vehicle.

The curvature of the reflective element may be determined by establishing curve parameters that provide a horizontal aspheric curvature that curves along a horizontal section of the reflective element, and a vertical aspheric curvature that curves along a vertical section of the reflective element. The horizontal aspheric curvature may be swept vertically across the reflective element on the vertical aspheric curvature. The vertical aspheric curvature may be swept horizontally across the reflective element on the horizontal aspheric curvature.

Optionally, a method for forming and manufacturing a mirror reflective element for a vehicular exterior rearview mirror assembly includes providing at least one glass substrate (e.g., a front substrate and a rear substrate for an electro-optic (e.g., electrochromic) mirror reflective element or a single substrate for a non-electro-optic mirror reflective element) for the reflective element that will be accommodated by a mirror head of the vehicular exterior rearview mirror assembly. The glass substrate is formed or bent to a bi-directional aspheric curved shape and a mirror reflector is coated at a surface of the bi-directional aspheric curved glass substrate. Curvature of the reflective element is established, at least in part, by coordinates of a driver's eye viewpoint location and coordinates of an image plane that will provide a desired view from the driver's eye viewpoint location based at least in part on the size of the reflective element. The size of the reflective element has a width dimension of less than 15 cm and a height dimension of less than 9 cm. The reflective element, when accommodated by the mirror head and with the vehicular exterior rearview mirror assembly disposed at a side of a vehicle equipped with the vehicular exterior rearview mirror assembly, and as viewed when the equipped vehicle is normally operated, provides a rearward view of at least 15 degrees horizontally relative to the side of the equipped vehicle.

The bi-directional aspheric curved glass substrate may have the mirror reflector coated at a rear surface thereof. The reflective element may have a reduced size that is at least 25 percent smaller than that of a planar reflective element of equivalent field of view. The image plane represents a desired field of view to a person viewing from the driver's eye viewpoint location, and an object plane represents a field of view of the person at a location rearward of the equipped vehicle. The mirror head is mountable at a passenger-side of the equipped vehicle, and the reflective element comprises a passenger-side reflective element.

The reflective element may comprise a non-electro-optic reflective element. The reflective element may comprise an electrochromic reflective element having a front substrate and a rear substrate and an electrochromic medium disposed between the front substrate and the rear substrate, and the rear substrate may comprise the bi-directional aspheric curved glass substrate.

The reflective element may be configured to provide a rearward field of view of at least 20 degrees relative to the side of the equipped vehicle. The reflective element may be configured to provide a rearward field of view of at least 30 degrees relative to the side of the equipped vehicle. The reflective element may be configured to provide a rearward field of view of at least 35 degrees relative to the side of the equipped vehicle.

The curvature of the reflective element may be determined by establishing curve parameters that provide a horizontal aspheric curvature that curves along a horizontal section of the reflective element, and a vertical aspheric curvature that curves along a vertical section of the reflective element. The horizontal aspheric curvature may be swept vertically across the reflective element on the vertical aspheric curvature. The vertical aspheric curvature may be swept horizontally across the reflective element on the horizontal aspheric curvature.

The curvature of the reflective element may be established, at least in part, by (i) a driver's eye viewpoint location, (ii) coordinates of an image plane that will provide a desired rearward view from the driver's eye viewpoint location, and (iii) coordinates of an object plane that represents a rearward field of view of a person viewing from the driver's eye viewpoint location, the object plane being at a location at least ten meters rearward of the driver's eye viewpoint location.

Changes and modifications to the specifically described embodiments may be carried out without departing from the principles of the present invention, which is intended to be limited only by the scope of the appended claims as interpreted according to the principles of patent law.

1. A vehicular exterior rearview mirror assembly, the vehicular exterior rearview mirror assembly comprising:
a mirror head;
a reflective element accommodated by the mirror head, the reflective element comprising a bi-directional aspheric curved glass substrate and a mirror reflector coated at a surface of the bi-directional aspheric curved glass substrate;
wherein the size of the reflective element has a width dimension of less than 15 cm and a height dimension of less than 9 cm;
wherein the reflective element, when accommodated by the mirror head and with the vehicular exterior rearview mirror assembly disposed at a side of a vehicle equipped with the vehicular exterior rearview mirror assembly, and as viewed when the equipped vehicle is normally operated, provides a rearward view of at least 15 degrees horizontally relative to the side of the equipped vehicle; and
wherein curvature of the reflective element is established, at least in part, by coordinates of a driver's eye viewpoint location and coordinates of an image plane that will provide a desired view from the driver's eye viewpoint location based at least in part on the size of the reflective element.

2. The vehicular exterior rearview mirror assembly of claim 1, wherein the bi-directional aspheric curved glass substrate has the mirror reflector coated at a rear surface thereof.

3. The vehicular exterior rearview mirror assembly of claim 1, wherein the reflective element has a reduced size that is at least 25 percent smaller than that of a planar reflective element of equivalent field of view.

4. The vehicular exterior rearview mirror assembly of claim 1, wherein the image plane represents a desired field of view to a person viewing from the driver's eye viewpoint location, and wherein an object plane represents a field of view of the person at a location rearward of the equipped vehicle.

5. The vehicular exterior rearview mirror assembly of claim 1, wherein the mirror head is mountable at a passenger-side of the equipped vehicle, and wherein the reflective element comprises a passenger-side reflective element.

6. The vehicular exterior rearview mirror assembly of claim 1, wherein the reflective element comprises a non-electro-optic reflective element.

7. The vehicular exterior rearview mirror assembly of claim 1, wherein the reflective element comprises an electrochromic reflective element having a front substrate and a rear substrate and an electrochromic medium disposed between the front substrate and the rear substrate, and wherein the rear substrate comprises the bi-directional aspheric curved glass substrate.

8. The vehicular exterior rearview mirror assembly of claim 1, wherein the reflective element is configured to provide a rearward field of view of at least 20 degrees relative to the side of the equipped vehicle.

9. The vehicular exterior rearview mirror assembly of claim 1, wherein the reflective element is configured to provide a rearward field of view of at least 30 degrees relative to the side of the equipped vehicle.

10. The vehicular exterior rearview mirror assembly of claim 1, wherein the reflective element is configured to provide a rearward field of view of at least 35 degrees relative to the side of the equipped vehicle.

11. The vehicular exterior rearview mirror assembly of claim 1, wherein the curvature of the reflective element is determined by establishing curve parameters that provide a horizontal aspheric curvature that curves along a horizontal section of the reflective element, and a vertical aspheric curvature that curves along a vertical section of the reflective element.

12. The vehicular exterior rearview mirror assembly of claim 11, wherein the horizontal aspheric curvature is swept vertically across the reflective element on the vertical aspheric curvature.

13. The vehicular exterior rearview mirror assembly of claim 11, wherein the vertical aspheric curvature is swept horizontally across the reflective element on the horizontal aspheric curvature.

14. A vehicular exterior rearview mirror assembly, the vehicular exterior rearview mirror assembly comprising:
a mirror head;
a reflective element accommodated by the mirror head, the reflective element comprising a bi-directional aspheric curved glass substrate and a mirror reflector coated at a surface of the bi-directional aspheric curved glass substrate;
wherein the size of the reflective element has a width dimension of less than 15 cm and a height dimension of less than 9 cm;
wherein the reflective element, when accommodated by the mirror head and with the vehicular exterior rearview mirror assembly disposed at a passenger side of a vehicle equipped with the vehicular exterior rearview mirror assembly, and as viewed when the equipped vehicle is normally operated, provides a rearward view of at least 30 degrees horizontally relative to the passenger side of the equipped vehicle;
wherein curvature of the reflective element is established, at least in part, by coordinates of a driver's eye viewpoint location and coordinates of an image plane that will provide a desired view from the driver's eye viewpoint location based at least in part on the size of the reflective element;
wherein the curvature of the reflective element is determined by establishing curve parameters that provide a horizontal aspheric curvature that curves along a horizontal section of the reflective element, and a vertical aspheric curvature that curves along a vertical section of the reflective element; and
wherein one selected from the group consisting of (i) the horizontal aspheric curvature is swept vertically across the reflective element on the vertical aspheric curvature and (ii) the vertical aspheric curvature is swept horizontally across the reflective element on the horizontal aspheric curvature.

15. The vehicular exterior rearview mirror assembly of claim 14, wherein the bi-directional aspheric curved glass substrate has the mirror reflector coated at a rear surface thereof.

16. The vehicular exterior rearview mirror assembly of claim 14, wherein the reflective element has a reduced size that is at least 25 percent smaller than that of a planar reflective element of equivalent field of view.

17. The vehicular exterior rearview mirror assembly of claim 14, wherein the image plane represents a desired field of view to a person viewing from the driver's eye viewpoint location, and wherein an object plane represents a field of view of the person at a location rearward of the equipped vehicle.

18. The vehicular exterior rearview mirror assembly of claim 14, wherein the reflective element comprises a non-electro-optic reflective element.

19. The vehicular exterior rearview mirror assembly of claim 14, wherein the reflective element comprises an electrochromic reflective element having a front substrate and a rear substrate and an electrochromic medium disposed between the front substrate and the rear substrate, and wherein the rear substrate comprises the bi-directional aspheric curved glass substrate.

20. The vehicular exterior rearview mirror assembly of claim 14, wherein the reflective element is configured to provide a rearward field of view of at least 35 degrees relative to the passenger side of the equipped vehicle.

21. A vehicular exterior rearview mirror assembly, the vehicular exterior rearview mirror assembly comprising:
a mirror head;
a reflective element accommodated by the mirror head, the reflective element comprising a bi-directional aspheric curved glass substrate and a mirror reflector coated at a surface of the bi-directional aspheric curved glass substrate;
wherein the size of the reflective element has a width dimension of less than 15 cm and a height dimension of less than 9 cm;
wherein the reflective element, when accommodated by the mirror head and with the vehicular exterior rearview mirror assembly disposed at a passenger side of a vehicle equipped with the vehicular exterior rearview mirror assembly, and as viewed when the equipped vehicle is normally operated, provides a rearward view of at least 30 degrees horizontally relative to the passenger side of the equipped vehicle;
wherein curvature of the reflective element is established, at least in part, by (i) a driver's eye viewpoint location, (ii) coordinates of an image plane that will provide a desired rearward view from the driver's eye viewpoint location, and (iii) coordinates of an object plane that represents a rearward field of view of a person viewing from the driver's eye viewpoint location, the object plane being at a location at least ten meters rearward of the driver's eye viewpoint location; and
wherein the reflective element has a reduced size that is at least 25 percent smaller than that of a planar reflective element of equivalent field of view.

22. The vehicular exterior rearview mirror assembly of claim 21, wherein the bi-directional aspheric curved glass substrate has the mirror reflector coated at a rear surface thereof.

23. The vehicular exterior rearview mirror assembly of claim 21, wherein the reflective element comprises a non-electro-optic reflective element.

24. The vehicular exterior rearview mirror assembly of claim 21, wherein the reflective element comprises an electrochromic reflective element having a front substrate and a rear substrate and an electrochromic medium disposed between the front substrate and the rear substrate, and wherein the rear substrate comprises the bi-directional aspheric curved glass substrate.

25. The vehicular exterior rearview mirror assembly of claim 21, wherein the reflective element is configured to provide a rearward field of view of at least 35 degrees relative to the passenger side of the equipped vehicle.

26. The vehicular exterior rearview mirror assembly of claim 21, wherein the curvature of the reflective element is determined by establishing curve parameters that provide a horizontal aspheric curvature that curves along a horizontal section of the reflective element, and a vertical aspheric curvature that curves along a vertical section of the reflective element.

27. The vehicular exterior rearview mirror assembly of claim 26, wherein the horizontal aspheric curvature is swept vertically across the reflective element on the vertical aspheric curvature.

28. The vehicular exterior rearview mirror assembly of claim 26, wherein the vertical aspheric curvature is swept horizontally across the reflective element on the horizontal aspheric curvature.
